(19) United States
(12) Patent Application Publication
(10) Pub. No.: US 2007/0085010 A1
(43) Pub. Date: Apr. 19, 2007

(54) Scintillator with a matrix material body carrying nano-material scintillator media

(75) Inventors: Sonia E. Letant, Livermore, CA (US); Chin Li Cheung, Lincoln, NE (US); Tzu-Fang Wang, Danville, CA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/450,089

(22) Filed: Jun. 8, 2006

Related U.S. Application Data
(60) Provisional application No. 60/690,750, filed on Jun. 14, 2005.

(51) Int. Cl. G01T 1/20

(52) U.S. Cl. 250/361 R

(57) ABSTRACT

A scintillator comprising a matrix material body and nano-material scintillator media carried by the matrix body. One embodiment provides a scintillator apparatus comprising a matrix material body with nano-material scintillator media carried by the matrix body. In one embodiment the nano-material scintillator media is quantum dots. In another embodiment the nano-material scintillator media is nanowires.

### CROSS-REFERENCE TO RELATED APPLICATIONS

This application claims the benefit of U.S. Provisional Patent Application No. 60/690,750 filed Jun. 14, 2005 and titled “Semiconductor Nano-Materials for Radiation Detection.” U.S. Provisional Patent Application No. 60/690,750 filed Jun. 14, 2005 and titled “Semiconductor Nano-Materials for Radiation Detection” is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to scintillator materials and more particularly to a scintillator comprising a matrix material body and nano-material scintillator media carried by the matrix body.

2. State of Technology

The publication, Chemistry Dictionary, chemicool.com© 2005, provides the following state of technology information, “Definition of Gamma-ray detector: X-rays and gamma-rays are high-energy electromagnetic waves with wavelengths less than 1 nm. X-rays usually originate from inner-electron transitions, and gamma-rays (which are of higher energy than X-rays) originate from nuclear decay processes. X-ray detectors are found in X-ray spectroscopy instruments and in X-ray diffractometers. Detection of gamma rays is necessary for characterization of radioactive samples and in elemental analysis by neutron activation analysis (NAA).”

There are three main designs for X-ray and gamma-ray detectors: gas-filled detectors, scintillation counters, and semiconductor detectors. (These detectors can also be used to detect and quantify charged particles such as alpha and beta particles.) In all of these designs, an incoming X-ray or gamma-ray collides with atoms in the detector material to produce photoelectrons. The photoelectrons collide within the detector to create more electrons. The number of electrons depends on the initial energy of the incident X-ray or gamma-ray. The output of the detector can therefore be analyzed based on pulse height to obtain a spectrum of the incident radiation.

Gas-Filled Detectors—Gas-filled detectors include proportional counters and Geiger counters. They consist of a metal container filled with a gas such as Ar, a window that can transmit X-rays and gamma-rays, such as Be or mylar, and a center wire that serves as an anode. A high voltage is maintained between the metal container and the anode. When high-energy rays or particles that pass into the detector collide with a gas atom, they ionize the atom to create a photoelectron. The photoelectron has a high energy and ionizes other gas atoms with which it collides. The result is a cascade of electrons that are accelerated and collected by the anode and detected as an electrical pulse.

Scintillators—A scintillator is a material that emits light when it absorbs radiation. The light pulse is then converted to an electrical pulse by a photomultiplier tube. Common scintillators are thallium-doped NaI, some plastics, anthracene and other organic solids, and liquid scintillation “cocktails,” which are mixed with the sample and are often used in biochemical applications.

Semiconductor Detectors—Semiconductors also produce photoelectrons when high-energy rays or particles strike the detector material. The most common X-ray and gamma-ray detectors use lithium-drifted silicon Si(Li) or lithium-drifted germanium Ge(Li). In these detectors, Li is incorporated into the semiconductor lattice by annealing the semiconductor with Li at a high temperature ˜500° C.). A voltage of approximately 1000 V is placed across the semiconductor material with two electrodes, and the electron cascade produced by a photoelectron is detected as an electrical pulse at the anode. In addition to being more robust than gas-filled or scintillator detectors, these semiconductor detectors also provide a much higher resolution. Their only disadvantage is the need for cooling, usually with liquid nitrogen, to decrease the dark noise of the detector and current-to-voltage preamplifier.

U.S. Published Patent Application No. 2004/0227095 for a radiation detector using a composite material by Jean-Louis Gerstenmayer and Jean-Michel Nunzi published Nov. 18, 2004 provides the following state of technology information: “In the field of X-ray imaging, there is a great demand for biomedical applications (X-rays with energies from 10 keV to 100 keV), for non destructive testing applications (X-rays with energies from 100 keV to 10 MeV) and nuclear instrumentation applications (X-ray energies from 0.5 MeV to 10 MeV). Concerning the above applications, there is a need for detectors with large surfaces able to replace radiological films by digitised imaging systems (in which the images are stored under digital form). For other applications, there is a need for producing detectors or sensors allowing ultra-rapid acquisition of images or time signals, the time of acquisition of an image being able to be as low as one pico-second, whilst the reading time may be longer. From an economic point of view, there is also a need for panels of photo-sensors of very large format, permitting cost effectiveness for the photovoltaic effect for producing electrical energy. Various laboratories are at present developing detectors using solid semiconductors (which can be monocrystalline or polycrystalline or even amorphous) as for example silicon, diamond (obtained by chemical deposit in vapour phase) CdTe or GaAs and their alloys. All these solid semiconductors lead to detectors with high production costs, taking into account the time needed for the chemical deposition in vapour phase or the crystal growth of semiconductors.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The present invention provides a scintillator comprising a matrix material body and nano-material scintillator media carried by the matrix body. One embodiment of the present invention provides a scintillator apparatus comprising a matrix material body with nano-material scintillator media carried by the matrix body. In one embodiment the nano-material scintillator media is semi-conductor quantum dots. In another embodiment the nano-material scintillator media is nanowires. Another embodiment of the present invention provides a detector apparatus comprising a matrix material body, a nano-material scintillator media carried by the matrix body, and a scintillation signal collector. Another embodiment of the present invention provides a method comprising the steps of forming a matrix material body and providing nano-material scintillator media carried by said matrix body.

One advantage of these new materials over standard Gamma ray detectors is that scintillation in the visible range can be achieved due to the quantum confined nature of the materials. This is important because the signal can be efficiently collected at room temperature with photodiodes, in a compact, efficient and inexpensive manner. Another advantage is the ease and low cost of fabrication, as well as the possibility of creating large area detectors.

The present invention has use as a radiation detector used for military or civil applications. The present invention has use as a radiation detector used in the field. For example, applications include luggage or cargo container inspection in airports and ports. The present invention has use as a radiation detector used in the laboratory to analyze samples. The present invention has use as a radiation detector used for applications such as: counter terrorism and contamination control. The present invention has use as a radiation detector used for applications such as: counter terrorism, contamination control, National Ignition Facility diagnostics, and other uses.

Designing radiation detectors based on nano-materials has the potential to free the radiation detection research field from conventional “crystal growth” type technologies and therefore to lead to drastic improvements such as flexibility, low cost, durability, increased detector area, improved scintillation output and visible scintillation wavelength.

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1A and 1B illustrate an embodiment of a scintillator apparatus constructed in accordance with the present invention.

FIG. 2 shows a quantum dot embedded in the matrix material body.

FIG. 3 shows the quantum dot being subjected to radiation.

FIG. 4A and 4B illustrate another embodiment of a scintillator apparatus constructed in accordance with the present invention.

FIG. 5 illustrates a detector apparatus constructed in accordance with the present invention.

FIG. 6 is a graph that shows scintillation output of a 25 mm thick quantum dot-nanoporous glass composite under alpha irradiation with a Curium 243-244 source.

FIG. 7 is a graph that shows scintillation output of a 25 mm thick quantum dot-nanoporous glass composite under gamma irradiation with an Americium 241 source.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

Present technology in gamma radiation detection suffers from flexibility and scalability issues. For example, bulk Germanium (Ge) provides very good energy resolution but requires operation at liquid nitrogen temperature. On the other hand, Cadmium-Zinc-Telluride (CZT) is a good room temperature detector but the size of the crystals that can be grown is limited to a few centimeters in each direction. Finally, the most commonly used scintillator, Sodium Iodide (NaI), can be grown as large crystals but suffers from a lack of energy resolution (only 7% at 1 MeV).

Recent advancements in nanotechnology have provided the possibility of controlling materials synthesis at the molecular level. Both morphology and chemical composition can now be manipulated, leading to radically new material properties due to a combination of quantum confinement and surface to volume ratio effects. One of the main effects of reducing the size of semiconductors down to nanometer dimensions is to increase the energy band gap, leading to visible luminescence, which suggests that these materials could be used as scintillators. The only test of this idea published to date is a preliminary study from ORNL, in which researchers showed that Cd(Se)ZnS dots could convert alpha rays into blue photons (blue scintillation).

Information about Applicants' invention is included in the article by S. E. Létant and Tzu-Fang Wang, Study of porous glass doped with quantum dots or laser dyes under alpha irradiation, Applied Physics Letters 88, 103110-103113 (2006). The article S. E. Létant and Tzu-Fang Wang, Study of porous glass doped with quantum dots or laser dyes under alpha irradiation, Applied Physics Letters 88, 103110-103113 (2006) is incorporated herein by this reference.

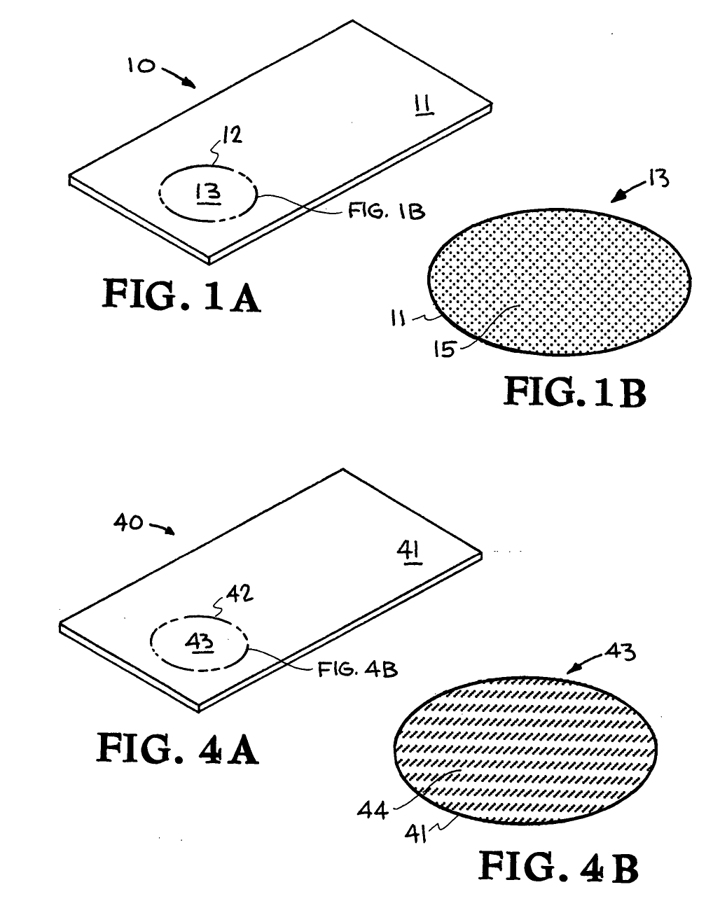

Referring to the drawings and in particular to FIGS. 1A and 1B, one embodiment of a scintillator apparatus constructed in accordance with the present invention is illustrated. This embodiment of a scintillator apparatus is designated generally by the reference numeral 10.

As illustrated in FIG. 1A, the scintillator apparatus 10 comprises a matrix material body 11 with nano-material scintillator media carried by the matrix body 11. A section 12 of the matrix material body 11 is shown enlarged at 13 in FIG. 1B. As shown by FIG. 1B, the enlarged section 13 of the matrix material body 11 has nanometer-sized scintillator media 14 embedded in the matrix material body 11.

The matrix material body 11 can be a porous matrix material body, a semiconductor material body, a transparent material body, a polymer body, a glass body, a sol-gel matrix body, a porous glass matrix body, a silicon matrix body, a germanium matrix body, a gallium arsenide matrix body, a gallium phosphide matrix body, a matrix material body doped with lithium, or other form of matrix material body.

The scintillator units 14 are semi-conductor quantum dots. Although both the synthesis and characterization of quantum dots have been developed for more than a decade, the applications explored to date seem to have focused on tagging, chemical and biological sensing, and lasing applications. The interest generated by quantum dots in both academic and industrial research communities comes from the fact that the optical properties of these materials are directly tied to their composition, size, and geometry, therefore allowing the engineering of key parameters such as emission wavelength and quantum efficiency.

Standard gamma-ray detection technology relies on cooled germanium detectors (0.2% energy resolution at 1.33 MeV) and on scintillating crystals such as sodium iodide (7% energy resolution at 662 keV). The main problem associated with the former is the necessity to cool and stabilize the detector at a temperature near liquid nitrogen to reduce thermal noise. The main problem associated with the latter is its poor energy resolution. The ideal detector material would have the energy resolution of a semiconductor, and the size and maintenance price of a scintillator. The scintillator apparatus 10 provides a nanocomposite QD scintillator with the following properties: 1) adequate energy resolution for isotopic identification (2%), 2) room temperature operation, 3) large volume, and 4) moderate cost.

The scintillator apparatus 10 solves this dilemma and leads to a new class of high energy resolution scintillators that will operate at room temperature, and more importantly, that do not rely on crystal growth, but on the assembly of nanometer-sized crystals in a sturdy matrix. Moreover, most scintillator materials have output wavelengths in the UV and blue (the most commonly used scintillator, sodium iodide, emits at 460 nm), wavelengths at which the quantum efficiency of photomultiplier tubes (PMT) is below 25%. This means that, even in an ideal situation, only ¼ of the photons produced in the scintillator material are detected. The use of quantum dots as a scintillator medium allows fine tuning of the output wavelength in the visible range and therefore, the use of avalanche photodiodes (APD) with quantum efficiencies of 70%. The visible band gap of quantum dots ensures both high photon output and efficient photon counting, which is essential for effective Poisson counting (ΔE/E=2.35/√(number of photons collected)).

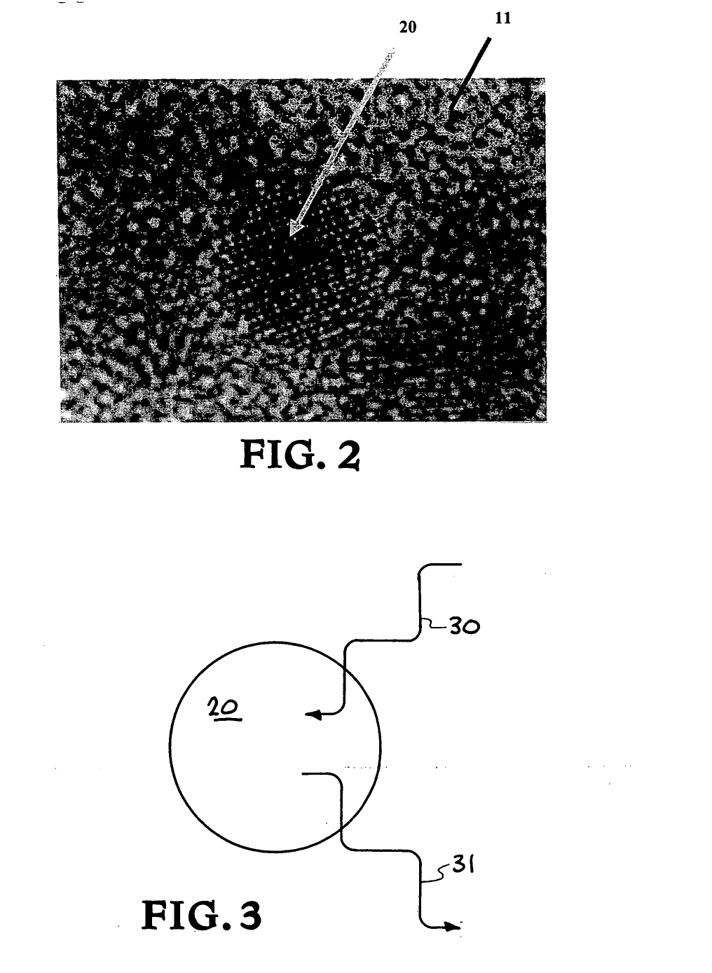

Referring now to FIG. 2, the quantum dot 20 is shown embedded in the matrix material body 11. Referring now to FIG. 3, the quantum dot 20 is shown being subjected to radiation 30. The radiation 30 produces scintillation 31 emanating from quantum dot 20. In the embodiment of a scintillator apparatus 10 the quantum dot 20 is immobilized in a nano-porous glass matrix 11.

Applicants' analysis indicates that an energy resolution of 2 percent could be achieved for quantum dot nanocomposite materials due to their visible band gap assuming that the system is linear. This approach would provide gamma-ray detectors with an energy resolution between the cooled semiconductor detectors and the inorganic scintillator crystals, without limitation on the volume of the detector. Increased dot density and optimized surface treatments will improve the light output by at least a factor 20, and efficient photon collection using APDs should increase the number of photons counted by a factor 10. In order to accommodate the increased dot density, the Stoke shift will have to be increased to limit re-absorption losses.

Referring to FIGS. 4A and 4B, another embodiment of a scintillator apparatus constructed in accordance with the present invention is illustrated. This embodiment of a scintillator apparatus is designated generally by the reference numeral 40.

As illustrated in FIG. 4A, the scintillator apparatus 40 comprises a matrix material body 41 with nano-material scintillator media carried by the matrix body 41. A section 42 of the matrix material body 41 is shown enlarged at 43 in FIG. 4B. As shown by FIG. 4B, the enlarged section 43 of the matrix material body 41 has nanometer-sized scintillator media 44 embedded in the matrix material body 41.

The scintillator units 44 are nanowires. The matrix material body 41 can be porous matrix material body, a semiconductor material body, a transparent material body, a polymer body, a glass body, a sol-gel matrix body, a porous glass matrix body, a silicon matrix body, a germanium matrix body, a gallium arsenide matrix body, a gallium phosphide matrix body, a matrix material body doped with lithium, or other form of matrix material body.

The embodiment of a scintillator apparatus 40 provides a further showing that the use of semiconductor-based nano-materials as a scintillator media for the detection of Gamma rays. These materials can be synthesized and used in the form of dots or wires embedded in transparent matrices, or in the form of porous semiconductor substrates. The main advantage of these new materials over standard Gamma ray detectors is that scintillation in the visible range can be achieved due to the quantum confined nature of the materials upon Gamma ray irradiation. This is important because the signal in the visible part of the spectrum can be efficiently collected at room temperature with photodiodes, in a compact, efficient and inexpensive manner. Another advantage is the ease and low cost of fabrication, as well as the possibility of creating large area/volume detectors.

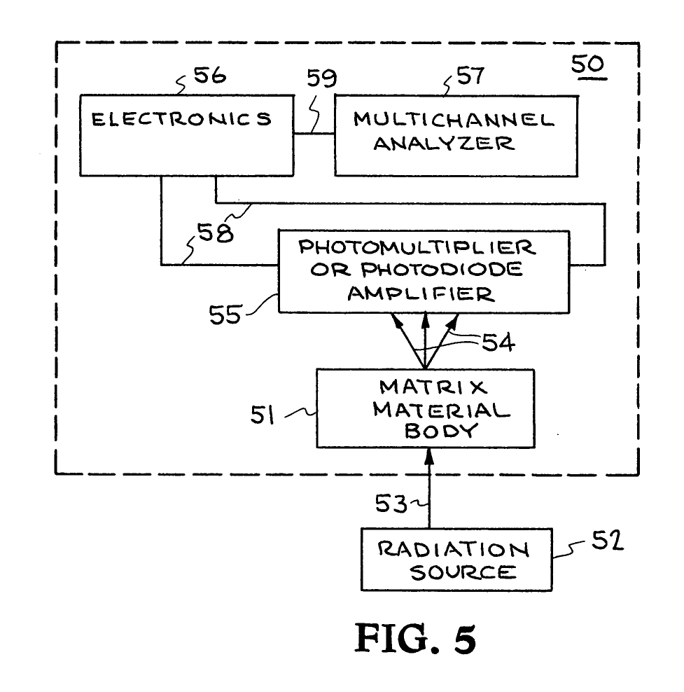

Referring to FIG. 5 a detector apparatus constructed in accordance with the present invention is illustrated. The detector apparatus is designated generally by the reference numeral 50. The detector apparatus 50 comprises a matrix material body 51, a nano-material scintillator media carried by the matrix body 51, and a scintillation signal collector.

The matrix material body 51 can be porous matrix material body, a semiconductor material body, a transparent material body, a polymer body, a glass body, a sol-gel matrix body, a porous glass matrix body, a porous silicon matrix body, a porous germanium matrix body, a porous gallium arsenide matrix body, a porous gallium phosphide matrix body, a matrix material body doped with lithium, or other form of matrix material body. The nano-material scintillator media can be quantum dots, nano-wires, or other nano-material scintillator media.

A radiation source 52 is shown directing radiation 53 onto the matrix material body 51 and the nano-material scintillator media carried by the matrix body 51. The radiation 53 strikes the nano-material scintillator media carried by the matrix body 51 producing scintillations 54. The scintillations 54 are detected by the scintillation signal collector. The scintillation signal collector can be any scintillation signal collector. The elements of the scintillation signal collector shown in FIG. 5 are a photomultiplier tube or photodiode 55, amplifier and electronics 56, and multichannel analyzer 57. The photomultiplier tube or photodiode 55 is connected to amplifier and electronics 56 by optic fibers or waveguides 58. The amplifier and electronics 56 are connected to the multichannel analyzer 57 by connection 59.

Standard gamma-ray detection technology relies on cooled germanium detectors (0.2% energy resolution at 1.33 MeV) and on scintillating crystals such as sodium iodide (7% energy resolution at 662 keV). The main problem associated with the former is the necessity to cool and stabilize the detector at a temperature near liquid nitrogen to reduce thermal noise. The main problem associated with the latter is its poor energy resolution. The ideal detector material would have the energy resolution of a semiconductor, and the size and maintenance price of a scintillator. The scintillator apparatus 50 provides a nanocomposite QD scintillator with the following properties: 1) adequate energy resolution for isotopic identification (2%), 2) room temperature operation, 3) large volume, and 4) moderate cost.

The scintillator apparatus 50 solves this dilemma and leads to a new class of high energy resolution scintillators that will operate at room temperature, and more importantly, that do not rely on crystal growth, but on the assembly of nanometer-sized crystals in a sturdy matrix. Moreover, most scintillator materials have output wavelengths in the UV and blue (the most commonly used scintillator, sodium iodide, emits at 460 nm), wavelengths at which the quantum efficiency of photomultiplier tubes (PMT) is below 25%. This means that, even in an ideal situation, only ¼ Of the photons produced in the scintillator material are detected.

Applicants have completed various tests and analysis of the present inventions. Porous VYCOR® was purchased from Advanced Glass and Ceramics (Holden, Mass.) in 1/16 inch thick sheets. As received, the material is constituted of an array of interconnected pores with a diameter of 4 nm and is opalescent. The porous glass matrix was slowly dissolved for 4 days in an aqueous solution containing 1% of hydrofluoric acid and 20% of ethanol per volume, rinsed in ethanol, and dried in air. The purpose of this step was to slightly enhance the pore size and to obtain a clear matrix. SEM top views of the material recorded after etching, cleaning, and drying without applying any conductive coating on the sample surface revealed an average pore diameter in the 10-20 nm range. The absorption curve of the same material shows very good transparency in the visible range. Porous glass constitutes a matrix of choice for scintillation applications because it is made of a succession of nanometer-sized cavities that can hold guest molecules while separating them from each other, therefore preventing self-quenching effects. In addition, it is sturdy, inert, and transparent.

CdSe/ZnS core shell quantum dots with a luminescence output at 540 nm were purchased from Evident Technologies (Troy, N.Y.) and suspended in toluene at a concentration of 10 mg/mL. The dry ‘thirsty’ porous glass pieces were immersed in the solutions of dots for 48 H with continuous stirring in order to allow homogeneous diffusion of the guest molecules into the nano-porous host matrix. They were then let to dry in order to evaporate the solvent.

The scintillation output of this material was studied under alpha radiation with a Curium source. The source (²⁴³⁻²⁴⁴Cm, 0.2 μC) was placed in contact with one side of the 25 mm thick porous glass sample and a PMT (model R1924A from Hamamatsu) probing a 1.5 cm diameter area rested directly on the other side to count visible photons coming out of the material. The source-sample-PMT assembly was placed in a black box in order to prevent ambient background photons to reach the PMT. Photons coming out of the nano-composite material sample under alpha irradiation were integrated for 10 H with an amplifier and a multi-channel analyzer.

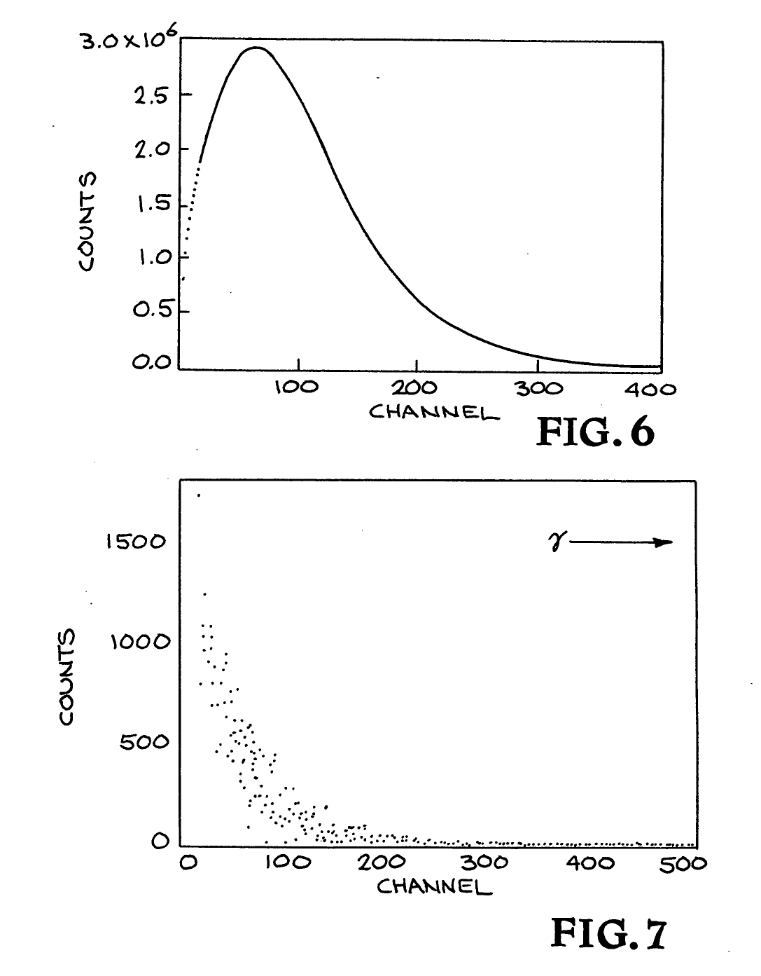

Referring now to FIG. 6, a graph shows scintillation output of a 25 mm thick quantum dot-nanoporous glass composite under alpha irradiation with a Curium 243-244 source. The spectrum was corrected from background radiation. FIG. 6 shows recent data of the photon output recorded on a nanoporous matrix infiltered with blue quantum dots, emitting at 510 nm. This data was corrected from background radiation and represents the scintillation histogram of the sample.

Referring now to FIG. 7, a graph shows scintillation output of a 25 mm thick quantum dot-nanoporous glass composite under gamma irradiation with an Americium 241 source. The spectrum was corrected from background radiation. Measured energy resolution of the 59 keV line of Americium 241 on this unoptimized device is 15%, which is a factor 2 improvement over NaI scintillators at this energy.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A scintillator apparatus, comprising:
a matrix material body, and
nano-material scintillator media carried by said matrix body.

2. The scintillator apparatus of claim 1 wherein said nano-material scintillator media carried by said matrix material body are quantum dots.

3. The scintillator apparatus of claim 1 wherein said nano-material scintillator media carried by said matrix material body are nanowires.

4. The scintillator apparatus of claim 1 wherein said matrix material body is a porous matrix material body.

5. The scintillator apparatus of claim 1 wherein said matrix material body is a semiconductor material body.

6. The scintillator apparatus of claim 1 wherein said matrix material body is a transparent material body.

7. The scintillator apparatus of claim 1 wherein said matrix material body is a polymer body.

8. The scintillator apparatus of claim 1 wherein said matrix material body is a glass body.

9. The scintillator apparatus of claim 1 wherein said matrix material body has a sol-gel matrix.

10. The scintillator apparatus of claim 1 wherein said matrix material body has a porous glass matrix.

11. The scintillator apparatus of claim 1 wherein said matrix material body has a porous silicon matrix.

12. The scintillator apparatus of claim 1 wherein said matrix material body has a porous germanium matrix.

13. The scintillator apparatus of claim 1 wherein said matrix material body has a porous gallium arsenide matrix.

14. The scintillator apparatus of claim 1 wherein said matrix material body has a porous gallium phosphide matrix.

15. The scintillator apparatus of claim 1 wherein said matrix material body is doped with lithium.

16. A detector apparatus, comprising:
a matrix material body,
a nano-material scintillator media carried by said matrix body, and
a scintillation signal collector.

17. The detector apparatus of claim 16 wherein said matrix material body is a porous matrix.

18. The detector apparatus of claim 16 wherein said nano-material scintillator media carried by said matrix material body are quantum dots.

19. The detector apparatus of claim 16 wherein said nano-material scintillator media carried by said matrix material body are nanowires.

20. The detector apparatus of claim 16 wherein said matrix material body is a porous matrix material body.

21. The detector apparatus of claim 16 wherein said matrix material body is a semiconductor material body.

22. The detector apparatus of claim 16 wherein said matrix material body is a transparent material body.

23. The detector apparatus of claim 16 wherein said matrix material body is a polymer body.

24. The detector apparatus of claim 16 wherein said matrix material body is a glass body.

25. The detector apparatus of claim 16 wherein said matrix material body has a sol-gel matrix.

26. The detector apparatus of claim 16 wherein said matrix material body has a porous glass matrix.

27. The detector apparatus of claim 16 wherein said matrix material body has a porous silicon matrix.

28. The detector apparatus of claim 16 wherein said matrix material body has a porous germanium matrix.

29. The detector apparatus of claim 16 wherein said matrix material body has a porous gallium arsenide matrix.

30. The detector apparatus of claim 16 wherein said matrix material body has a porous gallium phosphide matrix.

31. The detector apparatus of claim 16 wherein said matrix material body is doped with lithium.

32. The detector apparatus of claim 16 wherein said scintillation signal collector includes a photomultiplier tube.

33. The detector apparatus of claim 16 wherein said scintillation signal collector includes a photodiode.

34. The detector apparatus of claim 16 wherein said scintillation signal collector includes a photomultiplier tube or a photodiode and optic fibers or waveguides.

35. A method of making a scintillator, comprising the steps of:
forming a matrix material body, and
providing nano-material scintillator media carried by said matrix body.

36. The scintillator apparatus of claim 35 wherein said nano-material scintillator media carried by said matrix material body are quantum dots.

37. The scintillator apparatus of claim 35 wherein said nano-material scintillator media carried by said matrix material body are nanowires.

38. The scintillator apparatus of claim 35 wherein said matrix material body is a porous matrix material body.

39. The scintillator apparatus of claim 35 wherein said matrix material body is a semiconductor material body.

40. The scintillator apparatus of claim 35 wherein said matrix material body is a transparent material body.

41. The scintillator apparatus of claim 35 wherein said matrix material body is a polymer body.

42. The scintillator apparatus of claim 35 wherein said matrix material body is a glass body.

43. The scintillator apparatus of claim 35 wherein said matrix material body has a sol-gel matrix.

44. The scintillator apparatus of claim 35 wherein said matrix material body has a porous glass matrix.

45. The scintillator apparatus of claim 35 wherein said matrix material body has a porous silicon matrix.

46. The scintillator apparatus of claim 35 wherein said matrix material body has a porous germanium matrix.

47. The scintillator apparatus of claim 35 wherein said matrix material body has a porous gallium arsenide matrix.

48. The scintillator apparatus of claim 35 wherein said matrix material body has a porous gallium phosphide matrix.

49. The scintillator apparatus of claim 35 wherein said matrix material body is doped with lithium.
